(19) United States
(12) Patent Application Publication
(10) Pub. No.: US 2012/0047060 A1
(43) Pub. Date: Feb. 23, 2012

(54) Computerized Moniker-Based Equity Trading System and Method of Creation

(76) Inventor: Douglas Earl Fossler, II, Richardson, TX (US)

(21) Appl. No.: 12/861,505

(22) Filed: Aug. 23, 2010

(51) Int. Cl. G06Q 40/00

(52) U.S. Cl. 705/37

(57) ABSTRACT

A GUI with a relational database backend, and associated computer systems, setup for the real time automation, management, and distribution of financial products of monikers that are created by mathematical means. The GUI, website, relational database, and other associated computer systems will allow a trader the opportunity to trade monikers with other traders. The financial products are identified by the moniker (real name or fictitious name) of an individual, title, position, or character. The mathematical means of generating the financial products consist of the publicly traded companies that the moniker has interacted with. Data that is required to compute the financial products will come from the associated computer systems, other repositories, or forms of documentation acquired manually or automatically. Data is pulled automatically from the relational database to calculate the value of the financial products and then stores the results across multiple computer systems including the relational database accessed through the GUI by an end user.

### FIELD OF THE INVENTION

The present invention relates to the offering of financial products such as stocks, bonds, mutual funds, and other electronically traded products, through moniker association; more specifically, the present invention relates to an assembly of hardware capable of establishing and trading moniker-based securities, and a method of creation and use to enable a client to express a preference for a moniker-related security package and trade that package with other security holders with similar preferences for moniker-related securities.

### BACKGROUND OF THE INVENTION

The obsession with public figures such as celebrities, sports icons, artist, characters, and business professionals (herein collectively referred to as “monikers”, or individually referred to as a “moniker”) has created a demand for media that reports current news regarding monikers twenty-four hours a day. The attention that monikers receive has changed popular opinion, elections, public issues, law, and the direction of governments, businesses, and organizations. Currently, there is no financial instrument or vehicle allowing the public to invest in monikers in a public market.

Historically, the Dutch East India Company funded their foreign expeditions by issuing the first stock certificates, which gave the purchaser a promised percentage of return on their investment in the exotic adventure or locale. Companies, governments, and financial institutions now create equity and debt instruments that are tied to specific projects. The investing public exhibits an enormous interest in monikers and yet there is still no way for them to show or invest in that interest. Thus, an unsatisfied need exists in the industry for a way and means for the public to invest and trade in monikers via a financial product with others in the public.

### SUMMARY OF THE INVENTION

The present invention and objects therein are composed of the systems, methods, and computer program products that provide for the electronic trading of moniker financial products on a client/server model. This includes multiple server modules to service the plurality of individual trader systems (i.e., clients or end users), operationally interconnected over a network or the Internet. Due to the nature of the systems flexibility, it is possible the system can run as a web based, browser interface for the remote user's electronic device (i.e., computer or mobile phone).

Accordingly, the financial instrument system described herein comprises means for assessing a preference for a moniker-based asset collection; means for determining a relationship between the expressed preference for a moniker and a traded financial asset; means for setting an initial price for the moniker-based asset collection based on a weighted price of the asset collection; means for communicating the moniker-based asset collection and price information to one or more customers; means for accepting offers to buy and sell the moniker-based asset collection; and, means for completing the mutual offers by matching offers to buy with offers to sell the moniker-based asset collection.

The financial instrument system can assess a preference by utilizing a computerized opinion poll to determine interest in a particular moniker, including means for determining a relationship between the expressed preference for a moniker and an asset source by data mining of publicly available information regarding the moniker and correlating moniker connections with a plurality of publicly traded companies. Additionally, the means for setting an initial price for the asset collection for a moniker can be a weighted cost of the underlying asset collection plus a minimal handling fee. This fee may include an amount intended to compensate a moniker for use of the name for the financial instrument.

The present disclosure also describes a method for creating a moniker-based asset system for assessing a preference for a moniker-based asset collection; determining a relationship between the expressed preference for a moniker and a traded financial asset; setting an initial price for the moniker-based asset collection based on weighted price of the asset collection; communicating the moniker-based asset collection and price information to one or more customers; accepting offers to buy and sell the moniker-based asset collection; and, completing the mutual offers by matching offers to buy with offers to sell the moniker-based asset collection.

Another aspect of the present disclosure is a method for creating a computerized trading system for moniker-based financial instruments, implemented by creating one or more Stock Update Servers, Database Information Update Servers, Relational Database, Financial Servers, Customer Servers, Trading Pit Servers, Data Mining Servers, Staging Servers, and Web Interface Servers; establishing one or more Administrative Servers to provide centralized control for the system and manage all communication between all servers in the system; receiving stock price information from a plurality of equity markets on a real-time basis; loading the Stock Price Database in the Stocks Update Server with stock price data for publicly traded companies; automatically refreshing each stock price entry with a current stock price at either a predetermined frequency or when any relevant data changes; receiving, from an external network, information from a plurality of online news sources; loading a moniker Information Database in the Database Information Update Server with data automatically refreshed with current information at either a predetermined frequency or when any relevant data changes; joining the stock price database and the information database into a relational database; providing an association between the stock and the news about the stock, the moniker, and the economy; automatically assessing information that identifies a moniker with an indexed field in each of the selected plurality of publicly traded companies; and, creating relationships between the publicly traded companies represented by the stock prices and the news information to relationally assess price movement based upon moniker news; whereby the data structures, network, and connections support a trading system that creates, trades, and dissolves moniker-based financial instruments.

The method can provide a correlated connection of the publicly traded companies with relevant news stories factors in the interaction between a moniker and a publicly traded company, the age of the interaction, the potential popularity of the interaction based upon analysis of the news information, the publicly traded company's price per share, and the weight of the individual interaction. An algorithm can be used to calculate the interactions between the moniker and the publicly traded companies to factor the interactions with the moniker and to set weights for the sum of the interaction with each publicly traded company.

This disclosure also describes a method for creating moniker-based financial instruments in a computerized trading system by displaying the plurality of monikers, their related publicly traded companies, and the algorithmically created connections between the plurality of monikers and their related publicly traded companies to financial instrument managers for the said financial instrument managers to select which monikers will be the basis for potential moniker-based financial instruments; enabling communications between the financial instrument managers and the system to allow input from the financial instrument managers on which monikers will be the basis for potential moniker-based financial instruments and indexing said selected monikers; indexing and weighting the selected plurality of publicly traded companies, relating to the indexed monikers, by an algorithm to rank the degree of identification of the publicly traded company with the moniker; displaying a selection potential moniker-based financial instruments and their associated publicly traded companies to a plurality of users of the system; requesting and obtaining votes on the selection of monikers from a plurality of end users to determine potential future moniker-based financial instrument offerings; allowing financial instrument managers to select monikers that will be the bases for moniker-based financial products by analyzing end user voting results; accumulating interest in securities of the indexed publicly traded companies that are linked to the moniker to create the foundation for the moniker-based financial instrument; and, calculating the price per share for the moniker-based financial instrument by an algorithm which contains factors that are related to the publicly traded companies indexed in the said financial instrument and moniker-related information.

This method can provide an algorithm for calculating the price per share of the moniker-based financial instrument which incorporates all publicly available information about the royalty monies due to the moniker, total income earnings of the individual projects of the moniker, total income earnings from projects of the moniker, total income from products sold due to the moniker, and total income from lump sum payments due to the moniker; and provide preset percentage weights on the different category factors which can then be used to determine the price per share of the moniker-based financial instrument.

This disclosure also describes a method for maintaining moniker-based financial instruments in a computerized trading system by reweighting of the plurality of publicly traded companies related to the moniker within the moniker-related instrument as determined by the weighting algorithm, automatically at either a predetermined frequency or when any relevant data changes; and selling or acquiring shares of publicly traded companies, as determined by new news reports.

Alternatively, this method for trading moniker-based financial instruments in a computerized trading system can be implemented by displaying stock price and news information on a plurality of publicly traded companies related to the moniker-based financial object to a plurality of end users; displaying a plurality of moniker-based financial instruments being offered for purchase to the plurality of end users; enabling communication between the plurality of end users and the system to allow for input of a requested action in the account; and, accepting communication from the plurality of end users and executing the requested action, confirming the execution of the requested action wherein the requested action is for the purchase requests for initial offerings of shares of moniker-based financial instrument and the requested action is for the issuance of additional moniker-based shares. When the requested action is for purchase requests for non-initial offers of shares of moniker-based financial instruments and sale requests, matching complimentary purchase and sale end user requests in order to facilitate said requests; and, offering end user purchase of non-initial offers of shares of moniker-based financial instruments and sale requests to corporate accounts in the case that there are no matches with other end user requests in order to facilitate end user requests.

Payout requests are executed by sending a request to a financial instrument manager for the breakup of shares of the moniker-based financial instrument owned by the requestor end user and allocating appropriate securities shares proportionate to the shares of the moniker-based financial instrument in the form of paper certificates or electronic certificates; sending paper certificates or electronic certificates, dependant on the end user's preference as indicated in end user's payout request, to the end user as payout for the end user's shares in moniker-based financial instrument; and, updating client accounts and corporate accounts with the adjusted number of shares of moniker-based financial instrument, certificates, or cash depending on the details of the request or requests processed.

This disclosure also describes a method for liquidating a moniker-based financial instruments in a computerized trading system by scanning news information on a moniker to determine if a moniker no longer exists, automatically at either a predetermined frequency or when any relevant data changes; analyzing of the moniker-based financial instrument to determine whether said financial instrument should continue to exist and be offered to the plurality of end users; notifying end users of plurality of choices for payout and of discontinuance of specific moniker-based financial instrument, in the case that analysis determines that the said financial instrument will not continue to exist; whereby moniker-based financial instruments, will be inspired and created by current news, traded, and dissolved within an automated computerized process, allowing the multiplicity of end users to invest in a financial instrument alternative to traditional risk-analysis based financial instruments.

As may be readily appreciated and more fully described herein, this system provides a computerized trading system for moniker-based financial instruments, made up of one or more Stock Update Servers, Database Information Update Servers, Relational Database, Financial Servers, Customer Servers, Trading Pit Servers, Data Mining Servers, Staging Servers, and Web Interface Servers, each in electronic communication with each other; one or more Administrative Servers to provide centralized control for the system and manage all communication between all servers in the system connected to each other server within the system; stock price information reflecting the offer and sell price of each moniker-based financial instrument on a real-time basis loaded on the servers through their respective communications means; a Stock Price Database in the Stocks Update Server with stock price data for publicly traded companies; a refreshed stock price entry with a current stock price at either a predetermined frequency or when any relevant data changes for each moniker based financial asset; an external network providing information from a plurality of online news sources which is distributed to each moniker-based portfolio screen as it arrives within the server system; a moniker Information Database in the Database Information Update Server with information which is automatically refreshed with current information at either a predetermined frequency or when any relevant data changes; the stock price database and the information database information combined into a relational database; a coordinated display of an association between the stock and the news about the stock, the moniker, and the economy; an informational display that identifies a moniker with an indexed field in each of the selected plurality of publicly traded companies; and, a displayed relationship between the publicly-traded companies represented by the stock prices and the news information to relationally assess price movement based upon moniker news; whereby the data structures, network, and connections support a trading system that creates, trades, and dissolves moniker-based financial instruments.

### BRIEF DESCRIPTION OF THE DRAWINGS

FIG. 1 is a high level schematic diagram of how the client/server model works across a multitude of different networks to serve the end user client base that can be either stationary or mobile.

FIG. 2 is a schematic diagram of a computer network implementing an electronic moniker trading system.

FIG. 3 is a process flow chart of the life cycle of a financial instrument in the moniker auction trading computer system.

### DETAILED DESCRIPTION OF THE PREFERRED EMBODIMENTS

The present invention will now be described in further detail and makes reference to the figures which are only one example of an implementation. This embodiment description provides a new financial instrument linked to a moniker allowing the end user or holder of the financial instrument to enjoy both the psychological thrill of participating in holding a moniker (not unlike the holding and trading of sports cards) having a financial aspect which provides value which can be reduced to cash, upon liquidation of the holder or end user's account. However, due to the nature of software (different programming languages, algorithms, and computer hardware) the described solution described herein is the current preferred means of achieving the present invention, but not the only means of achieving this moniker-based marketable security. The examples described and included herein should not limit the scope of the present invention as they are only given to fully describe the present invention. As used herein, the word “server” can connote one or more coordinated hardware devices providing data storage and computation power to the users of the system without departing from the spirit or scope of this invention. These servers can be located either in a single geographic location or at a variety of remote locations. The form and substance of the screen shots are representative only and will vary based upon the material used to interface with the system. For example, a screen shot on a desktop client machine connected to the network described herein, may have more features available by radio button or pull-down menu as active screen elements; whereas the cell phone interface may be abbreviated or require subsidiary screens to fully present the alternatives to the end user. The browser interface of the current system can vary depending on the form factor adopted for this system of trading this new financial instrument.

### INTRODUCTION

The detailed description is the easiest implementation for a multitude of end users to interact directly with one another and the main systems that hold the financial instruments. The systems, methods, and computer program products of the present invention have a practical application in anonymously trading a variety of financial instruments tied to monikers. The scope of the present invention should not be limited to the following detailed description, but to the referred appended claims.

The present invention allows for separate parties to trade financial instruments tied to monikers by means of an auction process. The different parties can anonymously submit buy, sell, and exchange orders of financial instruments tied to monikers. Additionally the end user can put a time limit, monetary limit, or a break limit on the possible trades. This invention is considerably different from other trading systems that incorporate risk analysis to determine what financial instruments are offered. Instead this invention provides ties between the companies, entities, projects, and desired monikers.

Presently, trading systems do not generate financial instruments based on the interaction of the companies with monikers. Instead they opt for basing decisions on risk analysis. The present invention invests in financial instruments dependant on a moniker's interaction with companies and other factors, such as the length of time elapsed from the said interaction to the present can be used to select appropriate financial instruments. Additionally, the present invention weights the final outcome of the financial instruments based on the popularity of the interaction of the company and the moniker. In addition to other objects, the present invention allows for the compensation to the moniker for the use of the moniker itself where as other financial instruments do not owe compensation to their namesake.

Another key difference from current trading systems is that the present invention allows for the disaggregation of existing financial instruments for sale on other systems or for private accumulation. Allowing for the financial instruments to be broken down gives the end user a greater opportunity to manage their financial instruments. To extend the flexibility available to end users, the present invention permits future financial instruments to be chosen by the end users. Whether by voting, feedback, or other methods, participants can collectively choose the next financial instrument to be traded by expressing their preferences through the system described herein.

In the course of further explaining the specific details of the present invention there are several definitions that need to be made prior to continuing.

Moniker: This is an entity such as a character, stage name, real name, position title, title, imaginary name, formal name, nickname, a.k.a., professional name, pseudonym, cognomen, alias, legal name, allonym, ghostwriter, regional name, nom de guerre, nom de plume, user name, avatar, screen name, ring name, anagram, namesake, etc.

End User: Any entity that has setup an account online per the present invention.

Customer: See End User.

GUI: Graphical User Interface.

IPO: Initial Public Offering.

NASDAQ: National Association of Securities Dealers Automated Quotation.

DOW: DOW Jones Industrial Index.

EBITDA: Earnings Before Interest, Taxes, Depreciation and Amortization.

IMDB: Internet Movie Database.

### System Architecture

This system can be implemented as a new hardware solution, a software solution utilizing the resources of existing hardware infrastructures, or as a combination of both new hardware and software solutions without departing from the spirit or intent of this disclosure. The present invention can utilize a website to allow end users to perform the trades, or can be adapted to use any type of network and electronic device to form the necessary network to perform the trade and communicate the results of the interaction among the parties to the transactions. This may be accomplished with current or future web-programming languages such as Java, C++, C#, Perl, PHP, or database specific languages such as SQL which run on a variety of digital computers having memory, disk storage, input-output devices and circuitry for communication through wired, wireless or optical transmission. Database systems capable of performing the storage and updates of the system described in this disclosure could include Oracle System, SQL Server, mySQL Server, or DB1 system without departing from the spirit of this disclosure. The choice of hardware and software can be readily made by a person having ordinary skill in the art of large system development and readily accomplished without undue experimentation.

The present invention is described as follows with references to the figures previously described pertaining to the methods, systems, and computer software that encompass the present invention. It will be assumed that the different figures, flow charts, and diagrams can be implemented through hardware, software, or a combination of the two.

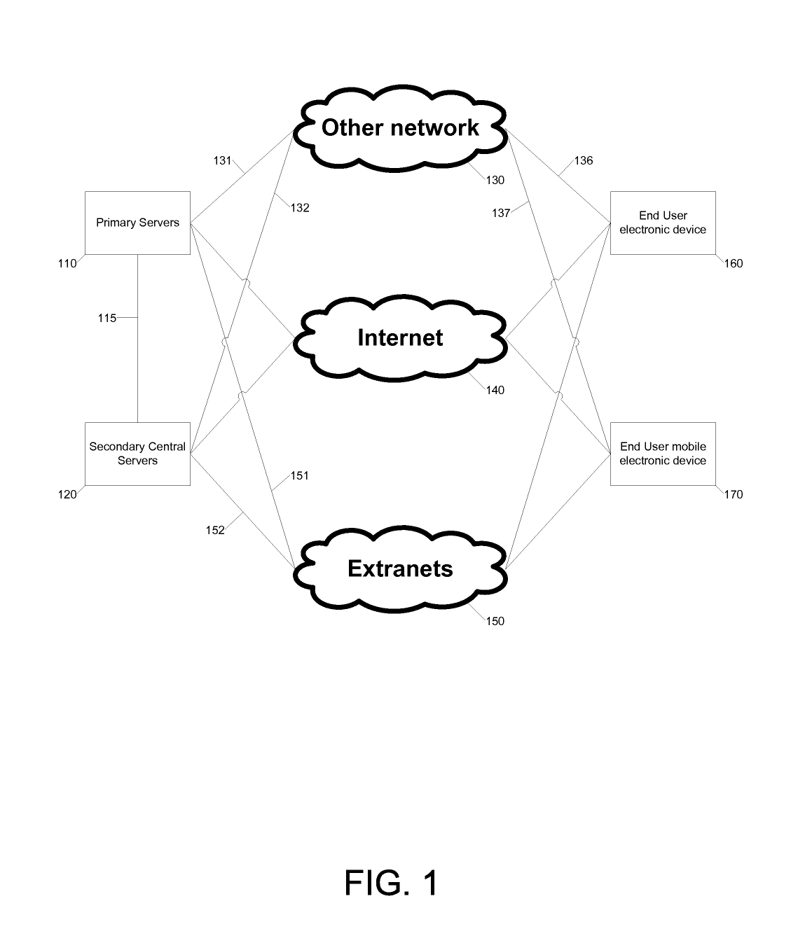

FIG. 1 is a high level schematic view of the networked computer trading system. System element 110 in FIG. 1 schematically depicts the primary servers that will perform all the necessary functions for the auction trading system to run for end users to access. In order to ensure an absolute minimum down time for end users system element 120 in FIG. 1 are the secondary servers that will only function if the primary servers 110 are down. There will be redundant data paths 115 shown schematically as a single line, but which could comprise a broadband network between the primary processing center and the secondary processing center to help ensure overall system availability up time.

The connection method between the primary and secondary server centers will be a variety of networks allowing end users (160, 170) access to the virtual trading floor. As depicted in FIG. 1, the network could be the public (or private) internet 140. Another possibility is 150 an extranet for private communication (151, 152) between the primary and secondary server centers for different end users. Yet another option to connect end users and the primary and secondary server centers is any other kind of network 130 which would connect the primary 110 or secondary 120 servers (131, 132) to the end user as shown by 136 to 160 or 137 to 170.

End users can use any kind of electronic device 160 or mobile electronic device 170 to navigate one of the network choices (130, 140, 150) to access the primary or secondary server centers. Once users have passed the networks and are at the primary 110 or secondary 120 server centers they are able to interface with each other as well as the primary 110 or secondary 120 server centers themselves.

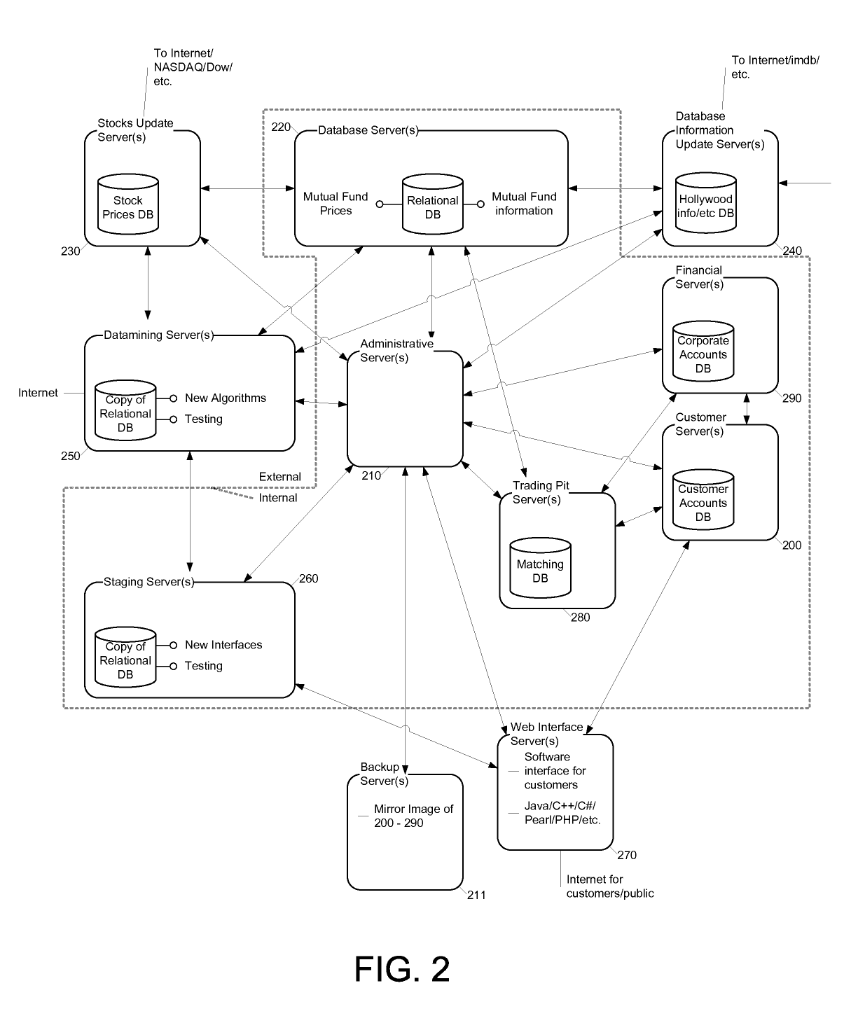

To explain in greater detail how the primary 110 and secondary 120 server centers could function, FIG. 2 depicts a diagram starting with the Administrative Server 210 that would control and oversee the entire operation of the computer system.

In order to generate the financial instruments that end users will trade on these computer systems; initial quantity and pricing information must be uploaded first. Stock prices are updated independently on a separate cluster, Server 230. Server 230 has a direct connection to outside systems (i.e., FIG. 1 at 130, 140, 150) to seek updates from external sources such as third-party companies, the world-wide web, and other third parties. This information can be automatically or manually updated.

Additional information used in the creation of the financial products is housed and updated in a separate Server system 240 providing generic information containing moniker-related datum. For example, names and relationships of public companies, current news information about a moniker, publically available legal documents related to a moniker. Server 240 has a direct connection to the outside sources (i.e., in FIG. 1 at 130, 140, 150) to pull updates from external sources such as third party companies, the world wide web, and third party individuals. This information can be automatically or manually updated.

The information from Stocks Update Server 230 and Database Information Update Server 240 are combined in the Relational Database Server 220. This Relational Database 220 will create ties between the stock prices and the information based on interaction, age of interaction, and popularity of interaction. An example equation for the interaction would be the following:

$$Z = {\sum }_{i = 1}^{v} ( {F}_{v} * {z}_{v} * [ {Ω}_{v} * {Copps}_{v} ] * {η}_{v} )$$

Where
Fᵥ is equal to an individual interaction between a moniker and a single company;
and
zᵥ is equal to the age of each individual interaction the moniker has with a single company;
and
Ωᵥ is equal to the popularity of each individual interaction the moniker has with a single company;
and
Coppsᵥ is equal to the company's adjusted price per share for each individual interaction the moniker has with a single company;
and,
   ηᵥ is equal to the weight of the individual interaction the moniker has with a single company based on the category.

Further description of this weighting process will be described later in this document. The data is updated in real time, which is used to update the financial instruments in real time.

To verify and update the weighting process that will be used to create the financial instruments and to not overload Relational Database Server 220, a separate bank of Data Mining Server 250 is used. Data Mining Server 250 will poll information from the Stocks Update Server 230, Database Information Update Server 240, and Relational Database Server 220 for recalculation and recalibration of the weighting factors, as well as retaining a copy of Relational Database Server 220. This would allow for Data Mining Server 250 to test weighting systems as well as create new financial instruments in real time.

Before changes to the process are updated on Relational Database Server 220 for availability to the end user, they will be tested on Staging Server 260. Staging Server 260 will also house a copy of Relational Database 220 allowing for real time testing of new interfaces for the end users as well as testing of new financial instrument offerings to the end users.

To interact with the trading system, end users will utilize electronic devices as shown in FIG. 1 160 and mobile electronic devices 170, via the Web Interface Server 270 in FIG. 2. This interface can be a hardware, software, or mixed solution to allow end users access via a GUI to their data, money, and financial instruments. Web Interface Server 270 will have a connection to the different possible networks (130, 140, 150) described in FIG. 1, permitting end users to access either server.

End user accounts reside on the Customer Accounts Server 200. Banking information, systematic programs, account history, existing purchase orders, existing sell orders, and other account specific information would be accessible to the end user via these server. The Customer Accounts Server 200 will interact with the Trading Pit Server 280 and the Financial Server 290.

Financial Server 290 will facilitate the interaction between corporate accounts and end user accounts for buy, sell, exchange, or payout orders. Financial Server 290 will also interact with Trading Pit Server 280 in order to allow for new financial instrument offerings and financial instrument maintenance.

The auction portion of the trading system will be run by Trading Pit Server 280 that will match buy, sell, and exchange requests automatically. The updated information on Trading Pit Server 280 will be feedback to the Relational Database Server 220 providing pricing adjustments and availability of blocks of stocks for investment. The data will also be routed to Financial Server 290 and Customer Server 200 in order to notify end users and financial instrument managers.

Secondary Servers 120 from FIG. 1 are displayed in FIG. 2 as a single form 211 with a single link to the Primary Servers in FIG. 2 through the Administrative Server 210. The Backup Server 211 will be identical to the servers depicted from 200 to 290 in FIG. 2 and will provide the same functionality. The Backup Server 211 will be utilized in case of any kind of failure to the primary servers 110 of FIG. 1 by having all interactions rerouted automatically. These secondary servers 120 can also be utilized to handle portions of the traffic load during maintenance windows while fixes or repairs are being made on the primary servers 110.

Screens would be the primary means (in a manner well known in this art) of inputting information into the system and receiving output from the system. All customer interactions from Electronic Devices 160 and Mobile Electronic Devices 170 (as shown in FIG. 1) will initially pass through Web Interface Server 270 of FIG. 2. Web Interface Server 270 will format the data request occurring in both directions for the purposes of this example.

A top-level interface would allow end users to interact with the trading system as a whole. When end users interact with the main interface they would be sending data to and receiving data from Staging Server 260 and Customer Server 200 to provide information relating to the financial instruments or a personal trading account. When requesting or sending data that does not reside on either of these two server groups the information is passed to the other necessary server groups based on the kind of interaction that the end user is requesting.

This interface, 270 of FIG. 2, would allow end users to request statistical information pertaining to a financial instrument using a variety of parameters chosen either by the end user or set by an administrator of the system, such as fund number, fund name, fund symbol, and CUSIP number. The end user may also select whether the quote will be displayed in graphic or text format. The volume of the fund as well as the amount or depth of information displayed such as the high and low or the history of the moniker may also be given. The end user can also control the temporal range of information presented by inputting a start and a stop date in a text box. Other options can be inserted into the quote request by listing more data entry options and fields in interface screen. When an end user requests a quote or quotes, the query passes though the Customer Server 200 and is filtered to the Trading Pit Server 280, as well as the Administrative Server 210, the Database Server 220 and the Stock Update Server 230. Information such as current market price, the daily high and low price, the daily number of executed trades, and other data can be distributed to the Web Interface Server 270 which will ultimately pass as illustrated in FIG. 1 from the Primary Servers 110 or the Secondary Servers 120 to the end user's electronic devices 160 or mobile electronic devices 170.

Another screen that could be interposed as shown in FIG. 2 at the Web Interface Server 270 to provide data transfer from a user to the system and from the system to the user would be a prospectus interface screen at 270 for end users to request documents pertaining to the financial instruments of interest through the Web Interface Server 270, the Administrative Server 210, the Trading Pit Server 280, and the Stocks Update Server 230. Information such as end-of-year statements for financial instruments, prospectuses for financial instruments, and other documentation pertaining to the financial instruments can be requested from a prospectus interface screen in a manner well known to those skilled in the Internet marketing of securities. Market charts interface screens could also be provided for end users to request graphical information for the financial instruments. An end user may also request data through the Web Interface Server 270, the Customer Server 200 to the Trading Pit Server 280 to obtain both historical and current data. Volume charts, high and low bid charts, trending charts, and other multidimensional graphs/charts of past historical data pertaining to the financial instruments could all be provided through this type of interface.

Another type of interface would be a hypothetical interface for end users that permits them to request analysis results pertaining to extrapolations on financial instruments. When an end user makes this kind of request it will be passed to the Staging Server 260, which in turn will send the request to Data Mining Server 250 to be analyzed and the results returned to the end user. Information such as potential earnings over a set time period, possible price at a set date, or anticipated volumes of trading over a time frame could be handled by this part of the interface.

Other screens in the hierarchy of screens available to the end user could, for example, provide a news interface for end users to request indirectly or directly related information to the financial instruments where the search for news information can be based on different categories, such as monikers, sectors or families of related monikers, funds, and time. When an end user makes this kind of request it will be passed to Database Information Update Server 240 which will run a search for related information based on a search algorithm. Related information can be newspaper stories, press releases, legal agreements, and other related information indirectly pertaining to the financial instruments.

A specific moniker-type field interface screen for end users to gauge industry trends and gather information relating to a sector may also be provided. This type of interface would provide links to interface screens that provide more specific information or allow for interaction with the selected fund type. This screen could also provide a logical offer site for display of advertisements. The fields in this type of screen could display a few sample fund names which are links that the end user can click on to go to another interface screen which provides the end user with information specific to that fund or to permit trading of that specific moniker instrument. This type of screen could also provide a button “More Monikers” allowing the end user to view more funds of the moniker-type. These screens could also provide fields to display the top performing funds in the moniker-type and provide a link on which the end user might click to direct them to a page displaying specific information regarding the selected fund. When an end user creates this kind of request, the system will return data from several places. The industry news would be derived from a search request to Database Information Update Server 240. Information related to the most volatile financial instruments can be provided from real-time information taken from Trading Pit Server 280. Information relating to all the currently offered financial instruments could be gathered from both Trading Pit Server 280 and Staging Server 260. Examples of information that could be available through this interface would be industry specific news stories, top ten performing financial instruments, a listing of the currently available financial instruments in the specific segment, and other sector specific information.

The system can also provide an account interface for end users to control their trading environment and navigate their account specific data. Depending on the type of request from the end user, the results that are returned will be generated at various points from different areas of FIG. 2. Current or historical information regarding the financial instruments owned by the end user, including graphs and charts of that data will be returned from Customer Server 200. Data for news results will be pulled from Database Information Update Server 240. Examples of this type of information presented as a composite result of the customer's information and information about the moniker itself are the number and type of financial instruments held by the end user, pie charts of a portfolio's diversification, performance of an end user's monikers over time, and other data related to the specific account for the end user.

An order interface would be created for end users to buy, sell, exchange, or request payouts from the trading system all in a manner well known in the field of on-line securities trading, including a “Cancel” button which would allow the user to cancel the current order displayed on the information screen. A buy or exchange request from the end user would be sent through the Web Interface Server 270 to the Customer Server 200 and, if necessary, be sent to the Trading Pit Server 280. If a payout or sell request is made by the end user then the data will be sent through the Customer Server 200 to the Financial Server 290 in order for the customer to receive monetary or certificate distribution. An example of this data would be a purchase request for a financial instrument, an exchange request from one financial instrument to a different financial instrument, and other transactions of financial instruments whether clerical or monetary.

Additional screens could provide a generic confirmation interface which an end user would access through the Web Interface Server 270 when submitting a request to verify the data prior to execution. This generic confirmation interface could be used to confirm a buy, sell, exchange, payout, data, request for news, request for a chart, banking information, systematic program, settings, quote, account setup, hypothetical, and other request based on the information from Web Interface Server 270. An example of this type of confirmation would be allowing the end user to confirm the purchase price for a buy order, the time out date for a sell request, or other request.

Other screens can provide the banking interface by which an end user would access banking information associated with their account. An end user may add, remove, or edit banking or payment information in their specific account through an interaction with Customer Server 200. Other potential interactions are: the removal of a bank account no longer owned by the end user, the addition of a new bank account that the end user just opened, changing the ABA routing number for a bank that has been bought out, or other related financial institution information, each of which can be accessed through alternative screens without departing from the spirit or intent of this disclosure.

Other screens could also provide a systematic interface that an end user would be shown when attempting to set-up periodic payments into or out of their specific account. An end user may add, remove, or edit a systematic program in their specific account through Web Interface Server 270 and the Customer Server 200, for example the creating of a systematic investment program into a financial instrument, the systematic withdrawal of money from a financial instrument to be deposited in a bank of record, or other related systematic activities tied to the end users account.

Still further alternative screens could allow an end user to alter the look, settings, data, or other aspect of the interface changeable by the end user. When an end user wishes to modify a specific Web Interface experience, a query may be sent through the Web Interface Server 270 with the settings option that can pull relevant settings-related data from the Administrative and Customer Servers (210, 200). An example would be to allow the end user to choose five financial instruments to always appear on their main interface when logging in that would pull information from the Trading Pit Server 280 through Customer Server 200. This screen could also provide preferred currencies for quotations (thereby allowing worldwide use of the system), favorite fund identifiers, favorite news sources, color-coding switches for individualization of the user screens.

Still further alternative screens could provide a “quick quotes” interface allowing the end user to enter, up to a set number, financial instruments for specific predefined data to be returned. When an end user enters and submits the required data for the quick quote interface, the data will be pulled from Trading Pit Server 280 through the Customer Server 200. Quotes would be the current or real-time price of a financial instrument, current daily high and low of the same financial instrument, and other data for the same specific financial instrument based on set criteria.

### Starting the Moniker Based System

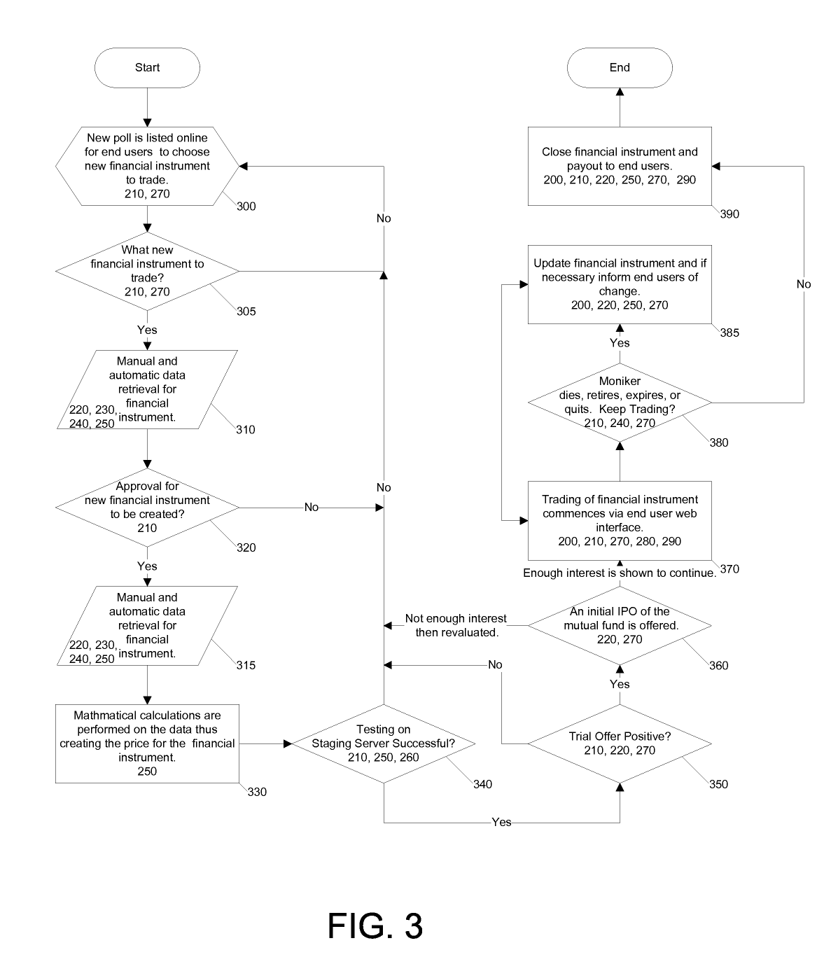

FIG. 3 is an example process flow for the life cycle of a financial instrument on this new trading platform that includes references to the Primary related Servers shown in FIG. 2. Initially, a new poll is offered to the end user through Web Interface Server 270 of FIG. 2. This polling 300 of FIG. 3 can be accomplished through a voting screen whereby the end user selects a moniker of interest from a preselected list or other variants such as the end user providing an indication of moniker interest by writing-in. Results of this polling process are compiled in real time on Data Mining Server 250 of FIG. 2 through Staging Server 260. When the polling period is complete, Data Mining Server 250 will analyze the data to determine monikers of interest 305 of FIG. 3 along with other statistical data 310 to determine if a new financial instrument warrants sufficient interest to be offered to the end users 320. If this process fails to elicit sufficient interest in any particular moniker and financial instrument package, then the process starts over with the end users being polled for further information 300 through Web Interface Server 270 of FIG. 2.

If the polling reflects sufficient interest, the potential new financial instrument goes to the approval step 320 of FIG. 3 where Data Mining Server information 310 is analyzed for financial instrument utility, i.e., can a financial instrument be adequately and diversely constructed to represent the selected moniker, on the Administrative Server 210 of FIG. 2.

If the approval is given to allow the trading of the new financial instrument, then data retrieval for the new financial instrument is gathered 315 of FIG. 3 from the different servers involved. Information would be pulled as shown in FIG. 2 from Stocks Update Server 230, Database Information Update Server 240, the Database Server 220, Administrative Server 210, and the different types of networks shown in FIG. 1 (130, 140, 150). Information regarding fields of interest or current popularity of a moniker family may also be pulled from the Trading Pit Server 280 and the Customer Server 200.

In order to create the first initial offering of the financial instrument, the necessary calculations will need to be parameterized in 300 of FIG. 3 by the above-mentioned algorithm of

$$Z = {\sum }_{i = 1}^{v} ( {F}_{v} * {z}_{v} * [ {Ω}_{v} * {Copps}_{v} ] * {η}_{v} ) ,$$

which is further discussed below. Data Mining Server 250 of FIG. 2 will accumulate the necessary data and run the algorithm until there is a market-clearing price point for the package of securities. In order to make sure that the first initial offering can be issued without fault for the end users, abnormal demand conditions, pricing, and random data will be provided to permit testing on the Staging Server 260 prior to allowing the public access to the new financial instrument, shown as stage 340 of FIG. 3.

### Initial Offering of Moniker-Based Instrument

Once the new financial instrument has been created and tested, a trial basis offer 350 is made to determine if an IPO is warranted 360 through the Web Interface Server 270 of FIG. 2 and a screen interface provided automatically to those end users who have expressed prior interest in trading such moniker-based instruments. If there is not enough public interest in the new financial instrument, the trial offer is rescinded and the process for searching for interest-provoking monikers starts over at 300 of FIG. 3. If there are sufficient requests for new shares, then the actual IPO 360 for the financial instrument takes place and data is updated from Database Server 220 of FIG. 2.

At IPO 360, trading will commence 370 of FIG. 3 through the agency of the Web Interface Server 270 of FIG. 2. End users requests for buy, sell, exchange, and payout orders will be filtered to the Trading Pit Server 280, Financial Server 290, and the Customer Server 200 depending on the type of action requested.

When a moniker no longer exists, financial instrument administrators will evaluate the need for the financial instrument based on said moniker to continue to be traded 380 as shown in FIG. 3 via the Administrative Server 210 in FIG. 2. The decision to continue to trade the financial instrument for a non-existent moniker can be put to popular vote, poll, or other data feedback from end users through a screen pushed to the user by the Web Interface Server 270.

If, after the expiration, death, or severance of the moniker, the fund continues to be available for trading 380 of FIG. 3, the financial instrument's parameters are updated 385 with the new or additional information. End users are then notified 385 of the financial instrument's continued existence, updates to the financial instrument, and any regulatory notifications are made through the Web Interface Server 270 of FIG. 2.

If the financial instrument is discontinued 390 of FIG. 3, then the public and end users are notified of the choices of payout from the liquidation of the financial instruments composing the moniker-based instrument and the moniker financial instrument is closed.

Financial instruments are updated by the current system in a standard data processing operation following the parameters as discussed herein. Old information stored on the database is updated in real time as that information is changed. However, while an end user holds a moniker, information related to that moniker will continue to be updated and available 385. Relevant data is matched to moniker-instruments to provide a non-risk-based analysis. However, it is expected that the diversification in each moniker-based instrument will provide sufficient risk-diversification to market changes to thereby provide some underlying stability to each moniker-based instrument, irrespective of the demand for the moniker expressed by the trading system described herein. As shown in FIG. 2, updating (220, 250) both the financial data 230 and the other news/information data 240 in real time is highly important for the moniker-based financial instruments to be traded 280 on a time-sensitive auction basis. After a financial instrument has passed the initial IPO 360 of FIG. 3, then updating of data and pricing 385 starts to run continually based on new information and different buy and sell prices.

Stock prices are updated when changes occur in other markets, and subsequently are updated on the Stocks Update Server 230 of FIG. 2 in real time. The Stocks Update Server 230 can pull information from other market floors such as the NASDAQ and DOW 130 of FIG. 1, the Internet 140, and extranets like the Reuters network 150. When new stocks are offered via the other services, network connections, or IPO's, then the Stocks Update Server 230 is updated either automatically or with the assistance of the Administrative Server 210.

Running in parallel with the Stocks Update Server 230, the Database Information Server 240 is updated in real time by pulling information from other services as shown in FIG. 1, such as IMDB 130, the Internet 140, and extranets 150. This updating can alter the financial characteristics of the moniker-based instruments. When the latest news stories are printed, posted online, or peer-reviewed via paper, published on websites, or published on other electronic media, then the Database Information Server 240 is updated either automatically or with the assistance of the Administrative Server 210 of FIG. 1.

Once the non-risk analysis based algorithm is run, the new price for the financial instrument overwrites the old price on the Data Mining Server 250. The new price is updated on the Data Mining Server 250 and is pushed to the Relational Database Server 220 to restart the process. The new price overwrites the old price on the Relational Database Server 220 to give access to the new price data to the trading end users accessing the system through the Trading Pit Server 280. The process then starts over and repeats indefinitely until the life cycle of the financial instrument has been terminated as described in FIG. 3. During each phase of this process, each stage can act independently of the others so that there may be several changes in the process that are not yet complete and of which only one is being committed at any given time.

To illustrate a means of calculating the financial instruments by a non-risk analysis method, the following algorithm is given as an example of one embodiment of this method. In this example the financial instrument calculated will represent a moniker based on the interaction between said moniker and publicly traded companies. If Z stands for the price of the financial instrument at any given time, expressed in a specific form of:

$$Z = {\sum }_{i = 1}^{v} ( {F}_{v} * {z}_{v} * [ {Ω}_{v} * {Copps}_{v} ] * {η}_{v} )$$

or in a more specific form as follows:

Z=A+B+C+D+E+U

Where the following data would be stored on the Relational Database Server 220, the Data Mining Server 250, and Staging Server 260.

A is the category that is equal to the adjusted total income of royalty monies due the moniker, such as CD royalties, DVD royalties, vinyl royalties, radio royalties, book royalties, investment dividends, long/short term capital gains, etc.

B is the category that is equal to the adjusted total income earnings from individual projects due the moniker, such as movie rights, back end points, etc.

C is the category that is equal to the adjusted total income earnings from series projects due the moniker, such as a TV series, a satellite series, etc.

D is the category that is equal to the adjusted total income earnings from products that are owned by the moniker, such as a company, clothing line, perfume line, etc.

E is the category that is equal to the adjusted total income earnings from products that are other companies' products (or not under the moniker) due the moniker, such a signed baseball cards, spokesperson for another product, etc.

U is the category that is equal to the adjusted total income from lump sum payments due the moniker such as cash, annual salary, advertisement money, bonuses, sale of investments, etc.

Given

$$A = l * {\sum }_{i = 1}^{N} {a}_{i}$$

$$B = m * {\sum }_{i = 1}^{N} {b}_{i}$$

$$C = o * {\sum }_{i = 1}^{N} {c}_{i}$$

$$D = p * {\sum }_{i = 1}^{N} {d}_{i}$$

$$E = q * {\sum }_{i = 1}^{N} {e}_{i}$$

$$U = t * {\sum }_{i = 1}^{N} {u}_{i}$$

Where the following data would be stored on the Relational Database Server 220, the Data Mining Server 250, and Staging Server 260, N is all companies that have had an interaction with the moniker in a certain category.

The weighted percentages l, m, o, p, q, t relate to each of the categories (A, B, C, D, E, or U) respectively.

Given

$$l = ( \frac{{\sum }_{i = 1}^{{N}_{n}} f}{y} )$$

$$m = ( \frac{{\sum }_{i = 1}^{{N}_{n}} g}{y} )$$

$$o = ( \frac{{\sum }_{i = 1}^{{N}_{n}} h}{y} )$$

$$p = ( \frac{{\sum }_{i = 1}^{{N}_{n}} j}{y} )$$

$$q = ( \frac{{\sum }_{i = 1}^{{N}_{n}} k}{y} )$$

$$t = ( \frac{{\sum }_{i = 1}^{{N}_{n}} s}{y} )$$

And

r=l+m+o+p+q+t=100%

Where the following data would be stored on the Relational Database Server 220, the Data Mining Server 250, and Staging Server 260 is all individual interactions that a single company has with the moniker in a certain category; and f, g, h, j, k, s are the total cumulative income for the moniker in a category.

Given

$${\sum }_{i = 1}^{{N}_{n}} f = {φ}_{{i}_{i}} + … + {φ}_{{i}_{n}} + … + {φ}_{{N}_{i}} + … + {φ}_{{N}_{n}}$$

$${\sum }_{i = 1}^{{N}_{n}} g = {ϕ}_{{i}_{i}} + … + {ϕ}_{{i}_{n}} + … + {ϕ}_{{N}_{i}} + … + {ϕ}_{{N}_{n}}$$

$${\sum }_{i = 1}^{{N}_{n}} h = {γ}_{{i}_{i}} + … + {γ}_{{i}_{n}} + … + {γ}_{{N}_{i}} + … + {γ}_{{N}_{n}}$$

$${\sum }_{i = 1}^{{N}_{n}} j = {ϖ}_{{i}_{i}} + … + {ϖ}_{{i}_{n}} + … + {ϖ}_{{N}_{i}} + … + {ϖ}_{{N}_{n}}$$

$${\sum }_{i = 1}^{{N}_{n}} k = {θ}_{{i}_{i}} + … + {θ}_{{i}_{n}} + … + {θ}_{{N}_{i}} + … + {θ}_{{N}_{n}}$$

$${\sum }_{i = 1}^{{N}_{n}} s = {μ}_{{i}_{i}} + … + {μ}_{{i}_{n}} + … + {μ}_{{N}_{i}} + … + {μ}_{{N}_{n}}$$

Where the following data would be stored on the Database Information Update Server 240:

φᵢ_{ᵢ} is the first interaction with the first company for the moniker in the A category.

φᵢ_{ₙ} is the last interaction with the first company for the moniker in the A category.

φ_{N}_{ᵢ} is the first interaction with the last company for the moniker in the A category.

φ_{N}_{ₙ} is the last interaction with the last company for the moniker in the A category.

Similarly, φ, γ, ω̅, θ, μ relate to the different categories (B, C, D, E, and U) respectively.

The total cumulative income for the moniker in all categories equals y.

y=f+g+h+j+k+s and a, b, c, d, e, u are the unadjusted total interactions with all publicly traded companies for the moniker.

Given

$${\sum }_{i = 1}^{n} a = ( ( \frac{{φ}_{{N}_{1}}}{y} ) * {z}_{1} * {α}_{1} + … + ( \frac{{φ}_{{N}_{n}}}{y} ) * {z}_{n} * {α}_{n} )$$

$${\sum }_{i = 1}^{n} b = ( ( \frac{{ϕ}_{{N}_{1}}}{y} ) * {z}_{1} * {β}_{1} + … + ( \frac{{ϕ}_{{N}_{n}}}{y} ) * {z}_{n} * {β}_{n} )$$

$${\sum }_{i = 1}^{n} c = ( ( \frac{{γ}_{{N}_{1}}}{y} ) * {z}_{1} * {Γ}_{1} + … + ( \frac{{γ}_{{N}_{n}}}{y} ) * {z}_{n} * {Γ}_{n} )$$

$${\sum }_{i = 1}^{n} d = ( ( \frac{{ϖ}_{{N}_{1}}}{y} ) * {z}_{1} * {Λ}_{1} + … + ( \frac{{ϖ}_{{N}_{n}}}{y} ) * {z}_{n} * {Λ}_{n} )$$

$${\sum }_{i = 1}^{n} e = ( ( \frac{{θ}_{{N}_{1}}}{y} ) * {z}_{1} * {ɛ}_{1} + … + ( \frac{{θ}_{{N}_{n}}}{y} ) * {z}_{n} * {ɛ}_{n} )$$

$${\sum }_{i = 1}^{n} u = ( ( \frac{{μ}_{{N}_{1}}}{y} ) * {z}_{1} * {σ}_{1} + … + ( \frac{{μ}_{{N}_{n}}}{y} ) * {z}_{n} * {σ}_{n} )$$

Where the following data would be stored on the Relational Database Server 220, the Data Mining Server 250, and Staging Server 260 α, β, Γ, Λ, ε, σ are the sum of a single company's interactions with the moniker, which can be more than one interaction.

Given:

$${α}_{i} = {copps}_{N} * {\sum }_{i = n}^{n} ( \frac{{A}_{{N}_{i}}^{T}}{{Co}_{N}^{T}} )$$

$${β}_{i} = {copps}_{N} * {\sum }_{i = n}^{n} ( \frac{{B}_{{N}_{i}}^{T}}{{Co}_{N}^{T}} )$$

$${Γ}_{i} = {copps}_{N} * {\sum }_{i = n}^{n} ( \frac{{C}_{{N}_{i}}^{T}}{{Co}_{N}^{T}} )$$

$${Λ}_{i} = {copps}_{N} * {\sum }_{i = n}^{n} ( \frac{{D}_{{N}_{i}}^{T}}{{Co}_{N}^{T}} )$$

$${ɛ}_{i} = {copps}_{N} * {\sum }_{i = n}^{n} ( \frac{{E}_{{N}_{i}}^{T}}{{Co}_{N}^{T}} )$$

$${σ}_{i} = {copps}_{N} * {\sum }_{i = n}^{n} ( \frac{{U}_{{N}_{i}}^{T}}{{Co}_{N}^{T}} )$$

Where the following data would be stored on the Database Information Update Server 240 and Stocks Update Server 230

A^{T} is equal to the total income of royalty monies due the moniker, such as CD royalties, DVD royalties, vinyl royalties, radio royalties, book royalties, investment dividends, long/short term capital gains, etc.

B^{T} is equal to the total income earnings from individual projects due the moniker, such as movie rights, back end points, etc.

C^{T} is equal to the total income earnings from series projects due the moniker, such as a TV series, a satellite series, etc.

D^{T} is equal to the total income earnings from products that are owned by the moniker, such as a company, clothing line, perfume line, etc.

E^{T} is equal to the total income earnings from products that are other companies' products (or not under the moniker) due the moniker, such a signed baseball cards, spokesperson for another product, etc.

U^{T} is equal to the total income from lump sum payments due the moniker such as cash, annual salary, advertisement money, bonuses, sale of investments, etc.

Co^{T} is equal to the total individual company's money, such as derived from EBITDA.

copps_{N} is equal to the NAV or stock price of the individual company at any given time.

And

zᵢ is equal to the age of each individual interaction the moniker has with a single company.

Given

$${z}_{i} = {\sum }_{v = 1}^{n} [ \frac{( ln ( λ ) + ( ξ + 1 ) )}{( ξ + 1 )} ]$$

Where the following data would be stored on the Database Information Update Server 240:

ξᵢ is equal to the total amount of time for the moniker to be active in the public for a given category.

λᵢ is equal to the time of the individual event of a subset of activities for the moniker.

This equation does not directly evaluate the financial instruments based on a risk analysis of the companies contributing to the make up of the moniker, but rather to factors such as the popularity of a moniker's interactions with publicly traded companies and the age of the interactions. To the extent that the moniker based financial instrument relates to publicly traded instruments, they indirectly provide a risk-related price adjustment. Thus, the present invention is differentiated from other exchange traded funds and the like which attempt to track broad indices or markets.

In order for end users to participate in the auction style trading of these moniker-based financial instruments, there is a need for a purchase and sale processes as described above. As previously noted, an end user determines an interest a moniker, queries the system described herein and is provided with either a new offer of a moniker-based instrument or is provided with information on existing moniker instrument prices. The end user can then input either an offer to purchase, or sell an existing moniker-instrument or request a payout which can either be a transfer to another financial institution or a cash buyout of the end-user's account. The system automatically checks the financial condition of the end-user's account by checking the availability of the portfolio being offered for sale, or debits the automatic payment portion of the end user's bank as set up originally and automatically confirms completion of the sale or expiration of the offer.

If the end user's choice is to submit the confirmation for the buy request, then the information is, as shown in FIG. 2, written to Customer Server 200, Financial Server 290, and Trading Pit Server 280. The data is stored on the Customer Server 200 so that the end user's activity history can be tracked. The data is stored on the Financial Server 290 so that the financial instrument managers are aware of the existing trades pending on the system in order to better manage the financial instruments as well as to ready any monetary transactions.

Relational Database Server 220, Stocks Update Server 230, Database Information Update Server 240, Trading Pit Server 280, Financial Server 290, and Customer Server 200 are notified of the necessary changes to make given the matching between a purchase and sell order. Relational Database Server 220, Stocks Update Server 230, and Database Information Update Server 240 are updated to reflect the latest change in current price for the financial instrument from the recently processed purchase/sell. Trading Pit Server 280 removes the purchase and sell request since they are no longer being actively traded. Financial Server 290 acts as an intermediary between the two end user accounts to facilitate the exchange of the shares. Customer Server 200 is updated for both to reflect the new data respectively and to generate notification for the end users of the successful trade.

In order for end users to move full shares of the underlying stocks which make up a moniker to different trading platforms, networks, or companies for the financial instruments, a need arises for a payout process. The end user may request a payout of the financial instrument by submitting the request using an interface screen through the Web Interface Server 270, all as previously described.

This data is passed to Customer Server 200 to check if there are enough full individual financial instrument shares that make up the financial instruments in the end user's account to fulfill the request. Customer Server 200 will also determine other aspects of the request are within acceptable parameters as described in the end user contractual arrangement and any exchange requirements.

Customer Server 200 will communicate with the end user providing information regarding any full shares of financial instruments that make up the moniker-based financial instrument the end user desires to receive as a payout. The end user is also notified of any partial shares of financial instruments that make up the financial instrument for which the end user desires a payout and the cash value of those partial shares. The end user will then have the option to continue with the order request through Web Interface Server 270. If the end user chooses to discontinue the payout request, the process ends and notification is sent to the end user. If the end user chooses to continue with the order request, the end user is presented with the option to generate either paper or electronic certificates and the option to select the method of delivery to the end user through Web Interface Server 270. The assets from the sale of the partial shares would be placed in the end user's account on Financial Server 290 and updated on Customer Server 200. Relational Database Server 220, Data Mining Server 250, and Staging Server 260 are updated with the new information. The Customer Server 200 generates notifications for the end user of the results of the payout.

In the foregoing drawings and specification, typical preferred embodiments of the invention have been presented for the purposes of illustration of the invention. They are used in a generic and descriptive sense only. They are not intended to be exhaustive and not for purposes of limitation. It is intended that the scope of the invention be limited not by this detailed description, but instead by the following claims.

What is claimed is:

1. A financial instrument system comprising:
means for assessing a preference for a moniker-based asset collection;
means for determining a relationship between the expressed preference for a moniker and a traded financial asset;
means for setting an initial price for the moniker-based asset collection based on weighted price of the asset collection;
means for communicating the moniker-based asset collection and price information to one or more customers;
means for accepting offers to buy and sell the moniker-based asset collection; and,
means for completing the mutual offers by matching offers to buy with offers to sell the moniker-based asset collection.

2. The financial instrument system of claim 1 wherein the means for assessing a preference is a computerized opinion polling determining interest in a particular moniker.

3. The financial instrument system of claim 1 wherein the means for determining a relationship between the expressed preference for a moniker and an asset source is data mining of publicly available information regarding the moniker and correlating moniker connections with a plurality of publicly-traded companies.

4. The financial instrument system of claim 1 wherein the means for setting an initial price for the asset collection for a moniker is a weighted cost of the underlying asset collection plus a minimal handling fee.

5. A method for creating a moniker-based asset system comprising:
assessing a preference for a moniker-based asset collection;
determining a relationship between the expressed preference for a moniker and a traded financial asset;
setting an initial price for the moniker-based asset collection based on weighted price of the asset collection;
communicating the moniker-based asset collection and price information to one or more customers;
accepting offers to buy and sell the moniker-based asset collection; and,
completing the mutual offers by matching offers to buy with offers to sell the moniker-based asset collection.

6. A method for creating a computerized trading system for moniker-based financial instruments, the method comprising:
creating one or more Stock Update Servers, Database Information Update Servers, Relational Database, Financial Servers, Customer Servers, Trading Pit Servers, Data Mining Servers, Staging Servers, and Web Interface Servers;
establishing one or more Administrative Servers to provide centralized control for the system and manage communication between all servers in the system;
receiving stock price information from a plurality of equity markets on a real-time basis;
loading a Stock Price Database in the Stocks Update Server with stock price data for publicly traded companies;
automatically refreshing each stock price entry with a current stock price at either a predetermined frequency or when any relevant data changes;
receiving from an external network, information from a plurality of online news sources;
loading a moniker Information Database in the Database Information Update Server with information which is automatically refreshed with current information at a predetermined frequency;
joining the Stock Price Database and the Information Database into a relational database; providing an association between the stock and the news about the stock, the moniker, and the economy;
automatically assessing information that identifies a moniker with an indexed field in each of the selected plurality of publicly traded companies; and,
creating relationships between the publicly traded companies represented by the stock prices and the news information to relationally assess price movement based upon moniker news;
whereby the data structures, network, and connections support a trading system that creates, trades, and dissolves moniker-based financial instruments.

7. The method of claim 6 wherein the correlated connection of the publicly traded companies with relevant news stories factors in the interaction between a moniker and a publicly traded company, the age of the interaction, the popularity of the interaction is based upon analysis of the news information, the publicly traded company's price per share, and the weight of the individual interaction.

8. The method of claim 6 wherein the algorithm used to calculate the interactions between the moniker and the publicly traded companies factor the interactions with the moniker and set weights for the sum of the interaction with each publicly traded company.

9. A method for creating moniker-based financial instruments in a computerized trading system, the method comprising:
displaying the plurality of monikers, their related publicly traded companies, and
the algorithmically created connections between the plurality of monikers and their related publicly traded companies to financial instrument managers for the said financial instrument managers to select which monikers will be the basis for potential moniker-based financial instruments;
enabling communications between the financial instrument managers and the system to allow input from the financial instrument managers on which monikers will be the basis for potential moniker-based financial instruments and indexing said selected monikers;
indexing and weighting the selected plurality of publicly traded companies, relating to the indexed monikers, by an algorithm to rank the degree of identification of the publicly traded company with the moniker;
displaying a selection of potential moniker-based financial instruments and their associated publicly traded companies to a plurality of users of the system;
requesting and obtaining votes on the selection of monikers from a plurality of end users to determine potential future moniker-based financial instrument offerings;
allowing financial instrument managers to select monikers that will be the bases for moniker-based financial products by analyzing end user voting results;
accumulating interest in securities of the indexed publicly traded companies that are linked to the moniker to create the foundation for the moniker-based financial instrument;
calculating the price per share for the moniker-based financial instrument by an algorithm which contains factors that are related to the publicly traded companies indexed in the said financial instrument and moniker-related information;

10. The method of claim 9, wherein the algorithm for calculating the price per share of the moniker-based financial instrument incorporates information about the royalty monies due to the moniker, total income earnings of the individual projects of the moniker, total income earnings from projects of the moniker, total income from products sold due to the moniker, and total income from lump sum payments due to the moniker.

11. The method of claim 9 wherein there will be preset percentage weights put on the different category factors which will be used to determine the price per share of the moniker-based financial instrument.

12. A method for maintaining moniker-based financial instruments in a computerized trading system, a method comprising:
reweighting of the plurality of publicly traded companies related to the moniker within the moniker-related instrument as determined by the weighting algorithm, automatically at either a predetermined frequency or when any relevant data changes;
selling or acquiring shares of publicly traded companies, as determined by the weighting algorithm, automatically at either a predetermined frequency or when any relevant data changes.

13. A method for trading moniker-based financial instruments in a computerized trading system, a method comprising:
displaying stock price and news information on a plurality of publicly traded companies related to the moniker-based financial object to a plurality of end users;
displaying a plurality of moniker-based financial instrument being offered for purchase to the plurality of end users;
enabling communication between the plurality of end users and the system to allow for input of a requested action in the account; and,
accepting communication from the plurality of end users and executing the requested action, confirming the execution of the requested action.

14. The method of claim 13 wherein the requested action is for the purchase requests for initial offerings of shares of moniker-based financial instrument.

15. The method of claim 13 wherein the requested action is for the issuance of additional moniker-based shares.

16. The method of claim 13 wherein the requested action is for purchase requests for non-initial offers of shares of moniker-based financial instruments and sale requests, matching complimentary purchase and sale end user requests in order to facilitate said requests; and,
offering end user purchase of non-initial offers of shares of moniker-based financial instruments and sale requests to corporate accounts in the case that there are no matches with other end user requests in order to facilitate end user requests.

17. The method of claim 13 wherein the requested action is for a payout request executed by:
sending the request to the financial instrument manager for the breakup of shares of the moniker-based financial instrument owned by the requestor end user and allocating appropriate securities shares proportionate to the shares of the moniker-based financial instrument in the form of paper certificates or electronic certificates;
sending paper certificates or electronic certificates, or funds, dependant on the end user's preference as indicated in end user's payout request and the composition of the fund itself, to the end user as payout for the end user's shares in moniker-based financial instrument; and,
updating client accounts and corporate accounts with the adjusted number of shares of moniker-based financial instrument, certificates, or cash depending on the details of the request or requests processed.

18. A method for liquidating a moniker-based financial instruments in a computerized trading system, a method comprising:
scanning news information on moniker to determine if moniker no longer exists, automatically at either a predetermined frequency or when any relevant data changes;
analyzing of the moniker-based financial instrument to determine whether said financial instrument should continue to exist and be offered to the plurality of end users;
notifying end users of plurality of choices for payout and of discontinuance of specific moniker-based financial instrument, in the case that analysis determines that the said financial instrument will not continue to exist;
whereby moniker-based financial instruments, will be inspired and created by current news, traded, and dissolved within an automated computerized process, allowing the multiplicity of end users to invest in a financial instrument alternative to traditional risk-analysis based financial instruments.

19. A computerized trading system for moniker-based financial instruments, comprising:
one or more Stock Update Servers, Database Information Update Servers, Relational Database, Financial Servers, Customer Servers, Trading Pit Servers, Data Mining Servers, Staging Servers, and Web Interface Servers, each in electronic communication with each other;
one or more Administrative Servers to provide centralized control for the system and manage communication between all servers in the system connected to each other server within the system;
stock price information reflecting the offer and sell price of each moniker-based financial instrument on a real-time basis loaded on the servers through their respective communications means;
a Stock Price Database in the Stocks Update Server with stock price data for publicly traded companies;
a refreshed stock price entry with a current stock price at either a predetermined frequency or when any relevant data changes for each moniker based financial asset;
an external network providing information from a plurality of online news sources which is distributed to each moniker-based portfolio screen as it arrives within the server system;
a moniker Information Database in the Database Information Update Server with information which is automatically refreshed with current information at either a predetermined frequency or when any relevant data changes;
the Stock Price Database and the Information Database into a relational database;
a coordinated display of an association between the stock and the news about the stock, the moniker, and the economy;
an informational display that identifies a moniker with an indexed field in each of the selected plurality of publicly traded companies; and,
a displayed relationship between the publicly-traded companies represented by the stock prices and the news information to relationally assess price movement based upon moniker news;
whereby the data structures, network, and connections support a trading system that creates, trades, and dissolves moniker-based financial instruments.
